(19) United States
(12) Patent Application Publication
(10) Pub. No.: US 2017/0335136 A1
(43) Pub. Date: Nov. 23, 2017

(54) HARD COATING FILM AND FLEXIBLE DISPLAY HAVING THE SAME

(71) Applicant: DONGWOO FINE-CHEM CO., LTD., Iksan-si (KR)

(72) Inventor: Seungwoo LEE, Hwaseong-si (KR)

(73) Assignee: DONGWOO FINE-CHEM CO., LTD., Iksan-si (KR)

(21) Appl. No.: 15/597,236

(22) Filed: May 17, 2017

(30) Foreign Application Priority Data
May 19, 2016 (KR) 10-2016-0061629

(51) Int. Cl. C09D 175/16; G02B 1/14; B05D 3/06; C09D 7/12

(52) U.S. Cl. CPC C09D 175/16; C09D 7/1216; G02B 1/14; B05D 3/067

(57) ABSTRACT

The present invention provides a hard coating film comprising: a substrate; a first hard coating layer formed on one surface of the substrate; and a second hard coating layer formed on the other surface of the substrate, wherein the first hard coating layer includes a cross-linked polymer of an oligomer having an elongation of 50 to 350%, the second hard coating layer includes a cross-linked polymer of an oligomer having an elongation of 0.1 to 50%, and the crosslinking density of the first hard coating layer is smaller than the crosslinking density of the second hard coating layer, and a flexible display having the hard coating film. The hard coating film according to the present invention has excellent impact resistance and curling properties and also has excellent bending resistance.

### TECHNICAL FIELD

The present invention relates to a hard coating film and a flexible display having the same. More particularly, the present invention relates to a hard coating film having excellent impact resistance and curling properties and also having excellent bending resistance, and a flexible display having the hard coating film.

### BACKGROUND ART

A hard coating film has been used for protecting the surface of various image displays including a liquid crystal display device (LCD), an electroluminescence (EL) display device, a plasma display (PD), a field emission display (FED) and the like.

Recently, a flexible display which can maintain display performance even when it is bent like a paper by using a flexible material such as plastic, instead of a conventional glass substrate having no flexibility, gains attention as a next generation display device. In this regard, there is a need for a hard coating film which not only has high hardness and good impact resistance but also has proper flexibility, without curling at the film edges during its production or use.

Korean Patent Application Publication No. 2014-0027023 discloses a hard coating film which comprises a supporting substrate; a first hard coating layer formed on one surface of the substrate and comprising a first photocurable cross-linked copolymer; and a second hard coating layer formed on the other surface of the substrate and comprising a second photocurable cross-linked copolymer and inorganic particles distributed in the second photocurable cross-linked copolymer, and the hard coating film exhibits high hardness, impact resistance, scratch resistance, and high transparency.

However, such a hard coating film has a problem that it does not have sufficient flexibility to be applied to a flexible display, and thus there is a need to develop a hard coating film having excellent flexibility and curling properties together with excellent impact resistance.

### DISCLOSURE

### Technical Problem

It is an object of the present invention to provide a hard coating film having excellent impact resistance and curling properties and also having excellent bending resistance.

It is another object of the present invention to provide a flexible display having the hard coating film.

### Technical Solution

In accordance with one aspect of the present invention, there is provided a hard coating film, comprising:

a substrate;

a first hard coating layer formed on one surface of the substrate; and

a second hard coating layer formed on the other surface of the substrate,

wherein the first hard coating layer includes a cross-linked polymer of an oligomer having an elongation of 50 to 350%, the second hard coating layer includes a cross-linked polymer of an oligomer having an elongation of 0.1 to 50%, and the crosslinking density of the first hard coating layer is smaller than the crosslinking density of the second hard coating layer.

In one embodiment of the present invention, the first hard coating layer may be formed by curing a first hard coating composition comprising an oligomer having an elongation of 50 to 350%, a photoinitiator and a solvent.

In one embodiment of the present invention, the second hard coating layer may be formed by curing a second hard coating composition comprising an oligomer having an elongation of 0.1 to 50%, a photoinitiator, inorganic nanoparticles, and a solvent.

In one embodiment of the present invention, the oligomer having an elongation of 50 to 350% may include a urethane acrylate oligomer.

In one embodiment of the present invention, the oligomer having an elongation of 50 to 350% may include a bifunctional urethane acrylate oligomer.

In one embodiment of the present invention, the oligomer having an elongation of 0.1 to 50% may include a polyfunctional urethane acrylate oligomer.

In one embodiment of the present invention, the oligomer having an elongation of 0.1 to 50% may include a trifunctional urethane acrylate oligomer.

In accordance with another aspect of the present invention, there is provided a flexible display having the hard coating film.

### Advantageous Effects

The hard coating film according to the present invention is excellent in impact resistance and curling properties and also has excellent bending resistance, and thus it can be effectively used for a flexible display.

### BEST MODE

Hereinafter, the present invention will be described in more detail.

One embodiment of the present invention relates to a hard coating film, comprising:

a substrate;

a first hard coating layer formed on one surface of the substrate; and

a second hard coating layer formed on the other surface of the substrate,

wherein the first hard coating layer includes a cross-linked polymer of an oligomer having an elongation of 50 to 350%, the second hard coating layer includes a cross-linked polymer of an oligomer having an elongation of 0.1 to 50%, and the crosslinking density of the first hard coating layer is smaller than the crosslinking density of the second hard coating layer.

Since the hard coating film according to an embodiment of the present invention has hard coating layers comprising cross-linked polymers of oligomers having elongations within different ranges on both surfaces of a substrate, and the crosslinking density of the hard coating layer comprising the cross-linked polymer of the oligomer having the smaller elongation value is larger than the crosslinking density of the hard coating layer comprising the cross-linked polymer of the oligomer having the larger elongation value, it may have excellent impact resistance and curling properties as well as excellent bending resistance.

The crosslinking density of the hard coating layer shows how closely the polymer network of the hard coating film is interconnected, and the crosslinking density can be measured by Flory-Rehner method which calculates the crosslinking density by swelling, or Mooney-Rivlin method which calculates the crosslinking density from the stress-strain measurement, or the like. For example, the crosslinking density of the hard coating layer can be measured by the method presented in the experimental examples described later.

In one embodiment of the present invention, the first hard coating layer may be formed by curing a first hard coating composition comprising an oligomer having an elongation of 50 to 350%, a photoinitiator and a solvent.

The oligomer having an elongation of 50 to 350% may include a urethane acrylate oligomer.

As the urethane acrylate oligomer, any oligomer being used in the art can be used without limitation as long as the elongation is 50 to 350%, and preferably, those prepared by subjecting an isocyanate compound having two or more isocyanate groups in the molecule and an acrylate compound having one or more hydroxy groups in the molecule to urethane reaction can be used.

Specific examples of the isocyanate compound may include tri-functional isocyanates derived from 4,4′-dicyclohexyl diisocyanate, hexamethylene diisocyanate, 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis (2,6-dimethylphenyl isocyanate), 4,4′-oxybis(phenylisocyanate), hexamethylene diisocyanate, and an adduct of trimethyl propanol and toluene diisocyanate, and these may be used alone or in combination of two or more.

Specific examples of the acrylate compound having a hydroxyl group may include 2-hydroxyethyl acrylate, 2-hydroxyisopropyl acrylate, 4-hydroxybutyl acrylate, caprolactone ring-opening hydroxyacrylate, a mixture of pentaerythritol tri/tetraacrylate, a mixture of dipentaerythritol penta/hexaacrylate, and these may be used alone or in combination of two or more.

The urethane acrylate oligomer may be, for example, a bifunctional urethane acrylate oligomer. As the bifunctional urethane acrylate oligomer, for example, CN9002, CN910A70, CN9167, CN9170A86, CN9200, CN963B80, CN964A85, CN965, CN966H90, CN9761, CN9761A75, CN981, CN991 and CN996 (commercially available from Sartomer Arkema). UF8001G and DAUA-167 (commercially available from KYOEISA Chemical) can be used.

The urethane acrylate oligomer can be polymerized during curing of the hard coating composition to form a cross-linked polymer.

The oligomer having an elongation of 50 to 350% may be contained in an amount of 1 to 90% by weight, preferably 5 to 85% by weight based on 100% by weight of the entire first hard coating composition. When the amount of the oligomer is less than 1% by weight, sufficient impact resistance cannot be obtained. When the amount of the oligomer is higher than 90% by weight, it may difficult to form a uniform cured coating film due to its high viscosity.

In one embodiment of the present invention, the second hard coating layer may be formed by curing a second hard coating composition comprising an oligomer having an elongation of 0.1 to 50%, a photoinitiator, inorganic nanoparticles, and a solvent.

The oligomer having an elongation of 0.1 to 50% may include a polyfunctional urethane acrylate oligomer.

As the polyfunctional urethane acrylate oligomer, any of those being used in the art can be used without limitation as long as the elongation is 0.1 to 50%, and for example, those prepared by subjecting an isocyanate compound having two or more isocyanate groups in the molecule and an acrylate compound having one or more hydroxy groups in the molecule to urethane reaction can be used.

Specific examples of the isocyanate compound may include tri-functional isocyanates derived from 4,4′-dicyclohexyl diisocyanate, hexamethylene diisocyanate, 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis (2,6-dimethylphenyl isocyanate), 4,4′-oxybis(phenylisocyanate), hexamethylene diisocyanate, and an adduct of trimethyl propanol and toluene diisocyanate, and these may be used alone or in combination of two or more.

Specific examples of the acrylate compound having a hydroxyl group may include 2-hydroxyethyl acrylate, 2-hydroxyisopropyl acrylate, 4-hydroxybutyl acrylate, caprolactone ring-opening hydroxyacrylate, a mixture of pentaerythritol tri/tetraacrylate, a mixture of dipentaerythritol penta/hexaacrylate, and these may be used alone or in combination of two or more.

The polyfunctional urethane acrylate oligomer may be, for example, a trifunctional urethane acrylate oligomer. As the trifunctional urethane acrylate oligomer, for example, CN9245S, CN9250A75, CN9260D75, CN970A60, CN998B80 and CN989 NS (commercially available from Sartomer Arkema), KOMERATE UT250 (commercially available from KPX Green Chemical) can be used.

The polyfunctional urethane acrylate oligomer can be polymerized during curing of the second hard coating composition to form a cross-linked polymer.

The oligomer having an elongation of 0.1 to 50% may be contained in an amount of 1 to 90% by weight, preferably 5 to 85% by weight based on 100% by weight of the entire second hard coating composition. When the amount of the oligomer is less than 1% by weight, sufficient impact resistance cannot be obtained. When the amount of the oligomer is higher than 90% by weight, it may difficult to form a uniform cured coating film due to its high viscosity.

The photoinitiator contained in the first hard coating composition and the second hard coating composition is used for photocuring of the hard coating composition, and can be used without particular limitation as long as it is an initiator being used in the art. The photoinitiator can be classified into a Type I photoinitiator in which radicals are generated by decomposition of molecules due to a difference in chemical structure or molecular binding energy, and a Type II (hydrogen abstraction type) photoinitiator in which tertiary amines are incorporated as a co-initiator. Specific examples of the Type I photoinitiator may include acetophenones such as 4-phenoxydichloroacetophenone, 4-t-butyldichloroacetophenone, 4-t-butyltrichloroacetophenone, diethoxyacetophenone, 2-hydroxy-2-methyl-1-phenylpropan-1-one, 1-(4-isopropylphenyl)-2-hydroxy-2-methylpropan-1-one, 1-(4-dodecylphenyl)-2-hydroxy-2-methylpropan-1-one, 4-(2-hydroxyethoxy)-phenyl(2-hydroxy-2-propyl)ketone, 1-hydroxycyclohexyl phenyl ketone or the like, benzoins such as benzoin, benzoin methyl ether, benzoin ethyl ether, benzyl dimethyl ketal or the like, acylphosphine oxides, and titanocene compounds. Specific examples of the Type 11 photoinitiator may include benzophenones such as benzophenone, benzoyl benzoic acid, benzoyl benzoic acid methyl ether, 4-phenylbenzophenone, hydroxybenzophenone, 4-benzoyl-4′-methyldiphenylsulfide, 3,3′-methyl-4-methoxybenzophenone or the like, and thioxanthones such as thioxanthone, 2-chlorothioxanthone, 2-methylthioxanthone, 2,4-dimethylthioxanthone, isopropylthioxanthone or the like. These photoinitiators may be used alone or in combination of two or more. In addition, Type I and Type II can be used together.

The photoinitiator may be used in an amount sufficient to proceed photopolymerization and may be used in an amount of 0.1 to 5% by weight, for example, 1 to 3% by weight based on 100% by weight of the entire hard coating composition. If the amount of the photoinitiator is less than the above range, the curing does not proceed sufficiently and thus it is difficult to realize the mechanical properties and adhesive force of the finally obtained hard coating film. If the amount of the photoinitiator exceeds the above range, the curing may excessively occur to generate cracks in the hard coating film.

The solvent contained in the first hard coating composition and the second hard coating composition may be used without particular limitation as long as it is used in the art. Specific examples of the solvent may include alcohols (methanol, ethanol, isopropanol, butanol, etc.), cellosolves (methyl cellosolve, ethyl cellosolve, etc.), ketones (methyl ethyl ketone, methyl butyl ketone, methyl isobutyl ketone, diethyl ketone, dipropyl ketone, cyclohexanone, etc.), hexanes (hexane, heptane, octane etc.), benzenes (benzene, toluene, xylene, etc.). These solvents may be used alone or in a combination of two or more.

The solvent may be contained in an amount of 5 to 90% by weight, preferably 10 to 85% by weight, based on 100% by weight of the hard coating composition. If the amount of the solvent is less than 5% by weight, the viscosity may increase to deteriorate workability. If the amount of the solvent is higher than 90% by weight, it is difficult to adjust the thickness of the coating film, and drying unevenness occurs, resulting in appearance defects.

The inorganic nanoparticles contained in the second hard coating composition may be used for improving the durability of the hard coating layer, and the inorganic nanoparticles having an average particle diameter of 1 to 100 nm, preferably 5 to 50 nm can be used. If the particle size is less than the above range, agglomeration occurs in the composition, and thus a uniform coating film cannot be formed and the effect of improving the durability cannot be obtained. On the other hand, if the particle size exceeds the above range, the optical properties of the finally obtained coating film may be deteriorated.

These inorganic nanoparticles can be metal oxides, and one selected from the group consisting of Al₂O₃, SiO₂, ZnO, ZrO₂, BaTiO₃, TiO₂, Ta₂O₅, Ti₃O₅, ITO, IZO, ATO, ZnO—Al, Nb₂O₃, SnO, MgO, and a combination thereof can be used. Preferably, Al₂O₃, SiO₂, ZrO₂ and the like can be used. The inorganic nanoparticles can be produced directly or commercially available. In the case of commercially available products, those dispersed in an organic solvent at a concentration of 10 to 80% by weight can be used. The inorganic nanoparticles may be contained in an amount of 5 to 50% by weight based on 100% by weight of the entire second hard coating composition. When the amount of the inorganic nanoparticles is less than 5% by weight, the durability of the coating film may be insufficient, and when the amount of the inorganic nanoparticles exceeds 50% by weight, the bending resistance is lowered and the appearance may be poor.

In the hard coating film according to the embodiment of the present invention, since only the second hard coating layer contains inorganic nanoparticles, the first hard coating layer containing no inorganic nanoparticles off-sets curls generated by the curing shrinkage of the second hard coating layer in the opposite direction, thereby providing a hard coating film exhibiting a high hardness while minimizing the occurrence of curling.

In addition, the first and second hard coating compositions may include a leveling agent in order to provide the smoothness and coating property of a coating film during coating of the compositions.

As the leveling agent, silicon-type, fluorine-type and acrylic polymer-type leveling agents being commercially available may be selected and used. For example, BYK-323, BYK-331, BYK-333, BYK-337, BYK-373, BYK-375, BYK-377, BYK-378 (BYK Chemie), TEGO Glide 410, TEGO Glide 411, TEGO Glide 415, TEGO Glide 420. TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300, TEGO Rad 2500 (Degussa), FC-4430 and FC-4432 (3M), or the like may be used. The leveling agent may be contained in an amount of 0.1 to 1% by weight based on 100% by weight of the first hard coating composition, and in an amount of 3 to 5% by weight based on 100% by weight of the second hard coating composition.

In addition to the above-mentioned components, the hard coating composition may further include components commonly used in the art, such as a ultraviolet stabilizer, a heat stabilizer, an antioxidant, a surfactant, a lubricant, an anti-fouling agent and the like.

Since the surface of the cured coating film is decomposed by continuous ultraviolet ray exposure to be discolored and crumbled, the ultraviolet stabilizer may be added for the purpose of protecting the hard coating layer by blocking or absorbing such ultraviolet rays. The ultraviolet stabilizer may be classified into an absorbent, a quencher, a hindered amine light stabilizer (HALS), and a radical scavenger depending on the action mechanism. Also, it may be classified into phenyl salicylate (absorbent), benzophenone (absorbent), benzotriazole (absorbent), and nickel derivative (quencher) depending on the chemical structure.

The heat stabilizer is a product that can be applied commercially, and a polyphenol type which is a primary heat stabilizer, a phosphite type which is a secondary heat stabilizer, and a lactone type can be used each individually or in combination thereof. The ultraviolet stabilizer and the heat stabilizer can be used by appropriately adjusting the content thereof at a level that does not affect the ultraviolet curability.

A hard coating film according to an embodiment of the present invention is prepared by coating a first hard coating composition and a second hard coating composition onto both surfaces of a transparent substrate followed by curing to form a first hard coating layer and a second hard coating layer.

As the transparent substrate, any plastic film having transparency can be used. For example, the transparent substrate can be selected from cycloolefin-based derivatives having units of monomer containing a cycloolefin such as norbornene and polycyclic norbornene monomer, cellulose (diacetyl cellulose, triacetyl cellulose, acetyl cellulose butylate, isobutyl ester cellulose, propionyl cellulose, butyryl cellulose, acetyl propionyl cellulose), ethylene-vinyl acetate copolymer, polyester, polystyrene, polyamide, polyether imide, polyacryl, polyimide, polyether sulfone, polysulfone, polyethylene, polypropylene, polymethylpentene, polyvinyl chloride, polyvinylidene chloride, polyvinyl alcohol, polyvinyl acetal, polyether ketone, polyether ether ketone, polymethyl methacrylate, polyethylene terephthalate, polybutylene terephthalate, polyethylene naphthalate, polycarbonate, polyurethane, and epoxy, and an unstretched, uniaxially or biaxially stretched film can be used.

The thickness of the transparent substrate is not particularly limited, but may be 8 to 1000 μm, preferably 20 to 150 μm. When the thickness of the transparent substrate is less than 8 μm, the strength of the film is lowered and thus the workability is lowered. When the thickness of the transparent substrate is more than 1000 μm, the transparency is lowered or the weight of the hard coating film is increased.

The hard coating composition may be coated onto the transparent substrate by suitably using a known coating process such as die coater, air knife, reverse roll, spray, blade, casting, gravure, micro gravure, spin coating, etc.

After the hard coating composition is coated onto the transparent substrate, a drying process may be carried out by vaporizing volatiles at a temperature of 30 to 150° C. for 10 seconds to one hour, more specifically 30 seconds to 30 minutes, followed by UV curing. The UV curing may be carried out by the irradiation of UV-rays at about 0.01 to 10 J/cm², particularly 0.1 to 2 J/cm².

One embodiment of the present invention relates to a flexible display having the above-described hard coating film. For example, the hard coating film of the present invention may be used as a window of the flexible display. Further, the hard coating film of the present invention may be used by attaching to a polarizing plate, a touch sensor, or the like.

The hard coating film according to one embodiment of the present invention may be used in liquid crystal devices (LCDs) of various operation modes, including reflective, transmissive, transflective, twisted nematic (TN), super-twisted nematic (STN), optically compensated bend (OCB), hybrid-aligned nematic (HAN), vertical alignment (VA)-type and in-plane switching (IPS) LCDs. Also, the hard coating film according to one embodiment of the present invention may be used in various image display devices, including plasma displays, field emission displays, organic EL displays, inorganic EL displays, electronic paper and the like.

Hereinafter, the present invention will be described in more detail with reference to examples, comparative examples and experimental examples. It should be apparent to those skilled in the art that these examples, comparative examples and experimental examples are for illustrative purposes only, and the scope of the present invention is not limited thereto.

### Preparation Example 1: Preparation of First Hard Coating Composition

60 wt % of a urethane acrylate oligomer (elongation: 70%, UF-8001G from KYOEISA Chemical), 37 wt % of methyl ethyl ketone, 2.5 wt % of a photoinitiator (1-hydroxycyclohexyl phenyl ketone), and 0.5 wt % of a leveling agent (BYK-3570 from BYK Chemie) were mixed using a stirrer and then filtered with a polypropylene (PP) filter to prepare a first hard coating composition.

### Preparation Example 2: Preparation of Second Hard Coating Composition

37 wt % of methyl ethyl ketone, 30 wt % of methyl ethyl ketone silica sol (MEK-AC-2140Z from Nissan Chemical Industries, particle diameter: 10-15 nm), 30 wt % of urethane acrylate oligomer (elongation: 17%, CN989 NS from Sartomer), 2.5 wt % of a photoinitiator (1-hydroxycyclohexyl phenyl ketone), and 0.5 wt % of a leveling agent (BYK-3570 from BYK Chemie) were mixed using a stirrer and then filtered with a polypropylene (PP) filter to prepare a hard coating composition.

### Examples 1 to 3 and Comparative Examples 1 to 4: Preparation of Hard Coating Film

### Example 1

After the first hard coating composition prepared in Preparation Example 1 was coated onto one surface of a substrate (polyimide film) in a thickness of 100 μm, the solvent was dried and the composition was cured by irradiating with an integrated amount (1.5 J/cm²) of ultraviolet ray to produce a first hard coating layer. Then, after the second hard coating composition prepared in Preparation Example 2 was coated onto the other surface of the substrate in a thickness of 20 μm, the solvent was dried and the composition was cured by irradiating with an integrated amount (1.0 J/cm²) of ultraviolet ray to produce a second hard coating layer.

The crosslinking densities of the first hard coating layer and the second hard coating layer were measured by the following method, and the crosslinking density values of the first hard coating layer and the second hard coating layer were 40% and 60%, respectively.

(1) Measurement of Crosslinking Density

The hard coating film was stored in a 15 ml tetrahydrofuran (THF) solution at room temperature for 24 hours and filtered. Then, the undissolved portion was dried at 100° C. for 3 hours and then dried again at 50° C. for 15 hours. At this time, the weight of the hard coating film before being immersed in the THF solution (W₀) and the weight of the hard coating film after being immersed in the THF solution (Wₜ) were measured, and the crosslinking density was calculated according to the following formula.

Crosslinking density (%)=Wₜ/W₀×100

### Example 2

After the first hard coating composition prepared in Preparation Example 1 was coated onto one surface of a substrate (polyimide film) in a thickness of 120 μm, the solvent was dried and the composition was cured by irradiating with an integrated amount (1.5 J/cm²) of ultraviolet ray to produce a first hard coating layer. Then, after the second hard coating composition prepared in Preparation Example 2 was coated onto the other surface of the substrate in a thickness of 20 μm, the solvent was dried and the composition was cured by irradiating with an integrated amount (0.8 J/cm²) of ultraviolet ray to produce a second hard coating layer.

The crosslinking densities of the respective hard coating layers were measured in the same manner as in Example 1, and the crosslinking density values of the first hard coating layer and the second hard coating layer were 35% and 50%, respectively.

### Example 3

After the first hard coating composition prepared in Preparation Example 1 was coated onto one surface of a substrate (polyimide film) in a thickness of 130 μm, the solvent was dried and the composition was cured by irradiating with an integrated amount (1.5 J/cm²) of ultraviolet ray to produce a first hard coating layer. Then, after the second hard coating composition prepared in Preparation Example 2 was coated onto the other surface of the substrate in a thickness of 20 μm, the solvent was dried and the composition was cured by irradiating with an integrated amount (0.8 J/cm²) of ultraviolet ray to produce a second hard coating layer.

The crosslinking densities of the respective hard coating layers were measured in the same manner as in Example 1, and the crosslinking density values of the first hard coating layer and the second hard coating layer were 30% and 50%, respectively.

### Comparative Example 1

After the first hard coating composition prepared in Preparation Example 1 was coated onto one surface of a substrate (polyimide film) in a thickness of 30 μm, the solvent was dried and the composition was cured by irradiating with an integrated amount (0.5 J/cm²) of ultraviolet ray to produce a first hard coating layer. Then, after the second hard coating composition prepared in Preparation Example 2 was coated onto the other surface of the substrate in a thickness of 100 μm, the solvent was dried and the composition was cured by irradiating with an integrated amount (1.5 J/cm²) of ultraviolet ray to produce a second hard coating layer.

The crosslinking densities of the respective hard coating layers were measured in the same manner as in Example 1, and the crosslinking density values of the first hard coating layer and the second hard coating layer were 40% and 35%, respectively.

### Comparative Example 2

After the first hard coating composition prepared in Preparation Example 1 was coated onto one surface of a substrate (polyimide film) in a thickness of 50 μm, the solvent was dried and the composition was cured by irradiating with an integrated amount (0.5 J/cm₂) of ultraviolet ray to produce a first hard coating layer. Then, after the first hard coating composition prepared in Preparation Example 1 was coated onto the other surface of the substrate in a thickness of 50 μm, the solvent was dried and the composition was cured by irradiating with an integrated amount (0.8 J/cm²) of ultraviolet ray to produce a second hard coating layer.

The crosslinking densities of the respective hard coating layers were measured in the same manner as in Example 1, and the crosslinking density values of the first hard coating layer and the second hard coating layer were 40% and 50%, respectively.

### Comparative Example 3

After the second hard coating composition prepared in Preparation Example 2 was coated onto one surface of a substrate (polyimide film) in a thickness of 60 μm, the solvent was dried and the composition was cured by irradiating with an integrated amount (0.5 J/cm²) of ultraviolet ray to produce a first hard coating layer. Then, after the second hard coating composition prepared in Preparation Example 2 was coated onto the other surface of the substrate in a thickness of 50 μm, the solvent was dried and the composition was cured by irradiating with an integrated amount (0.5 J/cm²) of ultraviolet ray to produce a second hard coating layer.

The crosslinking densities of the respective hard coating layers were measured in the same manner as in Example 1, and the crosslinking density values of the first hard coating layer and the second hard coating layer were 45% and 50%, respectively.

### Experimental Example 1: Evaluation of Bending Resistance at Room Temperature

Each of the hard coating films of Examples and Comparative Examples was folded in half so that the distance between the film surface was 6 mm. Next, when the film was spread again, it was confirmed with the naked eye whether or not cracks occurred in the folded portion, and thereby the bending resistance at room temperature was evaluated. The results are shown in Table 1 below.

<Evaluation Criteria>

Good: No occurrence of cracks in the folded portion

Poor: Occurrence of cracks in the folded portion

### Experimental Example 2: Evaluation of Bending Resistance at High Temperature-High Humidity

Each of the hard coating films of Examples and Comparative Examples was folded in half so that the distance between the film surface was 6 mm, and then the film was treated for 24 hours at 85° C. and 85% relative humidity Next, after the film was spread again, it was confirmed with the naked eye whether or not cracks occurred in the folded portion, and thereby the bending resistance at high temperature-high humidity was evaluated. The results are shown in Table 1 below.

<Evaluation Criteria>

Good: No occurrence of cracks in the folded portion

Poor: Occurrence of cracks in the folded portion

### Experimental Example 3: Evaluation of Impact Resistance

After bonding a glass with 50 μm OCA (elastic modulus: 0.08 Mpa) on one surface of each of the hard coating films of Examples and Comparative Examples, the weight of the maximum steel ball in which the glass at the lower part of the film was not destroyed when a steel ball was dropped thereon from a height of 50 cm was measured. The results are shown in Table 1 below.

### Experimental Example 4: Evaluation of Curl Generation

Each of the hard coating films of Examples and Comparative Examples was cut to a size of 10 cm×10 cm, and then allowed to stand at 25° C. and 48 RH % for 24 hours, and the degree at which each edge of the hard coating film was lifted from the bottom was evaluated. The results are shown in Table 1 below.

<Evaluation Criteria>

⊚: Average height of four edges was 20 mm or less

◯: Average height of four edges was 50 mm or less

Δ: Average height of four edges was higher than 50 mm

X: Four edges were completely lifted, and the film was curled in a cylindrical shape

TABLE 1

| | | Bending | | |
|---|---|---|---|---|
| | Bending | resistance at | | |
| | resistance at | high | | |
| | room | temperature- | Impact | |
| | temperature | high humidity | resistance | Curl |
| Example 1 | Good | Good | 60 g | ⊚ |
| Example 2 | Good | Good | 66 g | ⊚ |
| Example 3 | Good | Good | 70 g | ⊚ |
| Comparative | Poor | Poor | 30 g | X |
| Example 1 | | | | |
| Comparative | Poor | Poor | 35 g | X |
| Example 2 | | | | |
| Comparative | Poor | Poor | 35 g | X |
| Example 3 | | | | |

### Example 3

As can be seen from Table 1, the hard coating films of Examples in which the crosslinking density of the second hard coating layer comprising a cross-linked polymer of an oligomer having an elongation of 0.1 to 50% is larger than the crosslinking density of the first hard coating layer comprising a cross-linked polymer of an oligomer having an elongation of 50 to 350% were excellent in bending resistance, impact resistance and curling properties, whereas the hard coating films of Comparative Examples in which the crosslinking density of the second hard coating layer is smaller than the crosslinking density of the first hard coating layer or the elongations of the oligomers were within the same range were poor in bending resistance, impact resistance or curling properties.

Although particular embodiments of the present invention have been shown and described in detail, it will be obvious to those skilled in the art that these specific techniques are merely preferred embodiments, and various changes and modifications may be made to the invention without departing from the spirit and scope of the invention.

The substantial scope of the present invention, therefore, is to be defined by the appended claims and equivalents thereof.

1. A hard coating film, comprising:
a substrate;
a first hard coating layer formed on one surface of the substrate; and
a second hard coating layer formed on the other surface of the substrate,
wherein the first hard coating layer includes a cross-linked polymer of an oligomer having an elongation of 50 to 350%, the second hard coating layer includes a cross-linked polymer of an oligomer having an elongation of 0.1 to 50%, and the crosslinking density of the first hard coating layer is smaller than the crosslinking density of the second hard coating layer.

2. The hard coating film of claim 1, wherein the first hard coating layer is formed from a first hard coating composition comprising an oligomer having an elongation of 50 to 350%, a photoinitiator and a solvent.

3. The hard coating film of claim 2, wherein the oligomer having an elongation of 50 to 350% includes a urethane acrylate oligomer.

4. The hard coating film of claim 3, wherein the urethane acrylate oligomer includes a bifunctional urethane acrylate oligomer.

5. The hard coating film of claim 1, wherein the second hard coating layer is formed from a second hard coating composition comprising an oligomer having an elongation of 0.1 to 50%, a photoinitiator, inorganic nanoparticles, and a solvent.

6. The hard coating film of claim 5, wherein the oligomer having an elongation of 0.1 to 50% includes a polyfunctional urethane acrylate oligomer.

7. The hard coating film of claim 6, wherein the polyfunctional urethane acrylate oligomer includes a trifunctional urethane acrylate oligomer.

8. A flexible display having the hard coating film of claim 1.

9. A window of a flexible display having the hard coating film of claim 1.

10. A polarizing plate having the hard coating film of claim 1.

11. A touch sensor having the hard coating film of claim 1.
